(19) United States
(12) Patent Application Publication
(10) Pub. No.: US 2026/0282126 A1
(43) Pub. Date: Sep. 17, 2026

(54) ENHANCED MULTIPATH CONFIGURATION OF INDIRECT PATH ADDITION FIELD

(71) Applicant: Nokia Technologies Oy, Espoo (FI)

(72) Inventors: Ling YU, Kauniainen (FI); SunYoung LEE, Seoul (KR); Vinh VAN PHAN, Oulu (FI); Faranaz SABOURI-SICHANI, Aalborg (DK)

(21) Appl. No.: 19/472,165

(22) PCT Filed: Mar. 26, 2024
(86) PCT No.: PCT/EP2024/058085

§ 371 Date: Oct. 3, 2025

(30) Foreign Application Priority Data
Apr. 6, 2023 (FI) 20235403

(51) Int. Cl. H04W 76/14; H04W 24/10; H04W 40/22; H04W 76/27

(52) U.S. Cl. CPC H04W 76/14; H04W 24/10; H04W 40/22; H04W 76/27

(57) ABSTRACT

A method performed at a base station is provided. The method comprises receiving, from a User Equipment (UE) via a direct path, a measurement report. The measurement report comprises a list of one or more candidate relay UEs. The method further comprises determining to add an indirect path to the UE via a relay UE to have a multipath connection. The relay UE is selected from the one or more candidate relay UEs. The method further comprises transmitting, to the UE, a configuration message (e.g., an RRC reconfiguration message) comprising an identifier (ID) of the selected relay UE. The configuration message further indicates an RRC state of the selected relay UE.

The subject matter disclosed herein generally relates to wireless communication networks. More particularly, the subject matter disclosed herein relates to multipath communication.

### BACKGROUND

Wireless telecommunication systems are under constant development. There is a constant need for higher data rates and high quality of service. Reliability requirements are constantly rising and ways and means to ensure reliable connections and data traffic while keeping transmission delays minimal are constantly under development.

While fourth generation (4G) wireless mobile telecommunications technology, also known as Long Term Evolution (LTE) technology, was designed to provide high-capacity mobile multimedia with high data rates particularly for human interaction, next generation or fifth generation (5G) technology is intended to be used not only for human interaction, but also for machine type communications in so-called Internet of Things (IoT) networks.

5G enables using multiple input multiple output (MIMO) antennas, many base stations or nodes, including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. In general, 5G is integratable with existing legacy radio access technologies, such as the LTE.

In an example communication system, a user device (e.g., a user equipment, UE, or, more specifically, a 5G UE in a 5G network) such as a mobile terminal (subscriber) communicates over an air interface with a base station or access point referred to as a gNB in a 5G network. The access point (e.g., gNB) is illustratively part of an access network of the communication system. In general, the access point (e.g., gNB) provides access for the UE to a core network (CN), which then provides access for the UE to other UEs and/or a data network such as a packet data network (e.g., Internet). It may be that a single user device is connected to several access points (e.g., several base stations, or a combination of base stations and other access points) at the same time. In this way multiple paths may be generated for the communication.

A multiple access management service (MAMS) is proposed for next generation or 5G networks. Support of multipath communication over a with relay, where a mobile terminal (e.g., a remote UE) is connected to the network via direct and indirect paths, has a potential to improve the reliability/robustness as well as throughput. This multi-path relay solution can also be utilized to for UE aggregation where a UE is connected to the network via direct path and via another UE (e.g., a relay UE) using, e.g., a non-standardized UE-UE interconnection. UE aggregation aims to provide applications requiring high uplink (UL) bitrates on 5G terminals, in cases when normal UEs are too limited by UL-UE transmission power to achieve required bitrate, especially at the edge of a cell. Additionally, UE aggregation can improve the reliability, stability and reduce delay of services as well.

### LIST OF ABBREVIATIONS

In the present disclosure, the following abbreviations are used and should be understood in accordance with the given definitions
3GPP 3^{rd} Generation Partnership Project
5G 5^{th} Generation (Mobile Communication Network)
BS Base Station
CN Core Network
IE Information Element
DL Downlink
DRB Data Radio Bearer
eNB Evolved NodeB
EPS Evolved Packet System/4G
gNB Next Generation Node B/5G Base Station
ID Identifier
LTE Long Term Evolution
MAMS Multiple Access Management Service
MIMO Multiple Input Multiple Output
MP Multipath
NR New Radio/5G
NW Network
PDN Packet Data Network
PDU Protocol Data Unit
PLMN Public Land Mobile Network
QoS Quality of Service
RAN Radio Access Network
RRC Radio Resource Control
RSRP Reference Signal Received Power
RSRQ Reference Signal Received Quality
SD Sidelink Discovery
SL Sidelink
SRB Signaling Radio Bearer
U2N UE to Network
UE User Equipment/Mobile Terminal
UL Uplink

### SUMMARY

According to a first aspect, a method performed at a base station is provided. The method comprises receiving, from a User Equipment (UE) via a direct path, a measurement report. The measurement report comprises a list of one or more candidate relay UEs. The method further comprises determining to add an indirect path to the UE via a relay UE to have a multipath connection. The relay UE is selected from the one or more candidate relay UEs. The method further comprises transmitting, to the UE, a configuration message (e.g., an RRC reconfiguration message) comprising an identifier (ID) of the selected relay UE. The configuration message further indicates an RRC state of the selected relay UE.

According to a second aspect, a method performed at a User Equipment (UE) is provided. The method comprises transmitting, to a base station via a direct path, a measurement report comprising a list of one or more candidate relay UEs. The method further comprises receiving, from the base station, a configuration message (e.g., an RRC reconfiguration message) comprising an identifier (ID) of a relay UE selected from the one or more candidate relay UEs. The configuration message further indicates an RRC state of the selected relay UE. The method further comprises determining, based on the received configuration message, whether the selected relay UE is in RRC Connected state or not. Moreover, the method comprises initiating, upon determining that the selected relay UE is not in RRC Connected state, a procedure to the relay UE to trigger the relay UE transition to RRC Connected state.

In some embodiments, the RRC state of the selected relay UE is indicated explicitly in the configuration message.

In some embodiments, the RRC state of the selected relay UE is indicated by indicating whether a split Signaling Radio Bearer (SRB) is configured or not, or by indicating the path to be used by the remote UE for transmitting a response message to the configuration message.

In some embodiments, a split SRB is not configured when the selected relay UE is in RRC Connected state, and a split SRB is configured when the selected relay UE is not in RRC Connected state.

In some embodiments, the direct path is indicated when the selected relay UE is in RRC Connected state, and the indirect path is indicated when the selected relay UE is not in RRC Connected state.

In some embodiments, the RRC state of the selected relay UE is indicated by the configuration message further including an RRC container of the selected relay UE or not.

In some embodiments, the RRC container is not included in the configuration message when the selected relay UE is in RRC Connected state.

In some embodiments, the configuration message further indicates the path to be used by the remote UE for transmitting the RRC reconfiguration complete message.

In some embodiments, the method further comprises, upon determining that the selected relay UE is in RRC Connected state, transmitting an RRC reconfiguration complete message via the direct path to the base station.

In some embodiments, the procedure to the relay UE comprises one of the following: transmitting, via the indirect path, an RRC reconfiguration complete message to the selected relay UE, or transmitting, via the indirect path, a PC5-RRC message to the selected relay UE.

In some embodiments, the method further comprises receiving, from another base station, an indication of the RRC state of the selected relay UE. For example, the another base station may be a target base station of the indirect path.

In some examples, the UE may be configured to add the indirect path with the another base station. In some examples, the another base station selects the selected relay UE.

According to another aspect, an apparatus comprising at least one processor and at least one memory is provided. The memory includes executable instructions that, when executed by the at least one processor, cause the apparatus to receive, from a User Equipment (UE) via a direct path, a measurement report comprising a list of one or more candidate relay UEs, determine to add an indirect path to the UE via a relay UE selected from the one or more candidate relay UEs to have a multipath connection, and transmit, to the remote UE, a configuration message comprising an identifier (ID) of the selected relay UE, wherein the configuration message further indicates an RRC state of the selected relay UE.

In some embodiments, the instructions, when executed by the at least one processor, cause the apparatus further to perform a method according to any of the corresponding embodiments related to the first aspect.

In some examples, the apparatus is a base station or a NodeB (e.g., a g NodeB, or an e NodeB).

According to a further aspect, an apparatus comprising at least one processor and at least one memory is provided. The memory includes executable instructions that, when executed by the at least one processor, cause the apparatus to transmit, to a base station via a direct path, a measurement report comprising a list of one or more candidate relay UEs, receive, from the base station, a configuration message comprising an identifier (ID) of a relay UE selected from the one or more candidate relay UEs, wherein the configuration message further indicates an RRC state of the selected relay UE, determine, based on the received configuration message, whether the selected relay UE is in RRC Connected state or not; and initiate, upon determining that the selected relay UE is not in RRC Connected state, a procedure to the relay UE to trigger the relay UE transition to RRC Connected state.

In some embodiments, the instructions, when executed by the at least one processor, cause the apparatus further to perform a method according to any of the corresponding embodiments related to the second aspect.

In some examples, the apparatus is a user apparatus, such as, e.g., a user equipment (UE), a mobile device, a terminal device, a user terminal, a subscriber terminal, or the like.

### BRIEF DESCRIPTION OF THE DRAWINGS

In the following, example embodiments will be described in greater detail with reference to the attached drawings, in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4A illustrates an example setup of the method for indirect path addition.

FIG. 4B depicts another example setup for indirect path addition in an intra gNB scenario.

FIG. 5 shows the general method procedure for multipath configuration involving another UE and an explicit indication of an indirect path addition.

FIG. 6 shows an embodiment of the method with implicit indication of an indirect path addition using a split SRB.

FIG. 7 another embodiment of the method with implicit indication of an indirect path addition using a RRC container.

FIG. 8 visualizes another embodiment with explicit indication of an indirect path addition using a configuration message.

### DETAILED DESCRIPTION

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the embodiments and in the claims, serve to illustrate the embodiments with reference to the drawings, without limiting it to these examples only.

The embodiments and features, if any, disclosed in the following description that do not fall under the scope of the independent claims are to be interpreted as examples useful for understanding various embodiments of the invention.

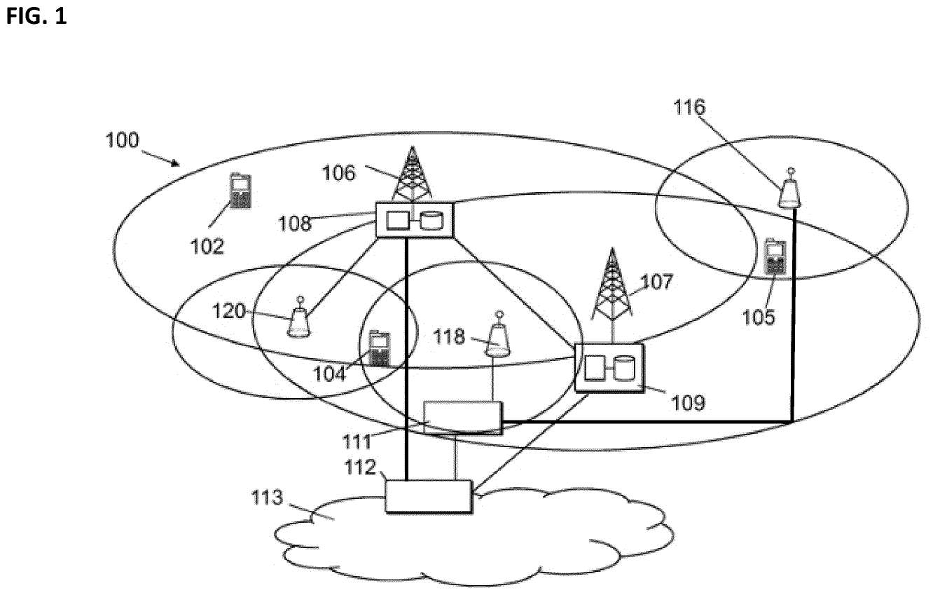

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, user equipment (UE) 102, 104, 105 are provided wireless access via at least one base station (e.g., next generation NB, gNB), similar wireless transmitting and/or receiving node or network node. Typically, a wireless communication system (e.g., wireless communication system 100) comprises more than one base station, in which case the base stations may also be configured to communicate with one another through logical interfaces (such as, e.g., Xn/X2) running over links, wired or wireless, designed for the purpose. Base stations may be controlled or assisted by at least one appropriate controller apparatus, so as to enable operation thereof and management of mobile communication devices in communication with the base stations. The controller apparatus may be located in a radio access network (e.g., wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller (RNC). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various radio access technologies (RATs), also referred to as wireless communication technologies, or telecommunication standards described hereinbelow. As illustrated in FIG. 1, while one of the base stations may act as a “serving cell” for UEs, each UE may also be capable of receiving signals from (and possibly within communication range of) one or more other cells (which might be provided by the base stations and/or any other base stations), which may be referred to as “neighboring cells”.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, wireless local area network (WLAN) and may be WLAN access points (Aps).

An example of wireless communication systems are architectures standardized by the 3rd Generation Partnership Project (3GPP), such as the long-term evolution (LTE) of the Universal Mobile Telecommunications System (UMTS) radio-access technology or LTE Advanced (LTE-A), which employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as, e.g., control plane Radio Resource Control (RRC) protocol terminations towards the communication devices.

A more recent example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QOS) support, and some on-demand requirements for e.g., QoS levels to support Quality of Experience (QoE) of user point of view. Also network aware services and applications, and service and application aware networks may bring changes to the architecture. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

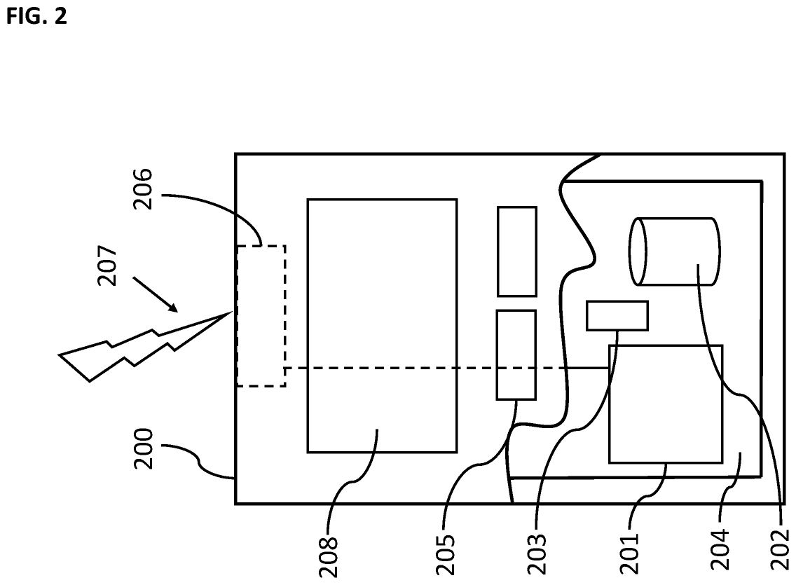

A possible (mobile) communication device 200 will now be described in more detail with reference to FIG. 2 showing a schematic, partially sectioned view. Such a mobile communication device 200 is often referred to as user equipment (UE), user device or terminal device. An appropriate mobile communication device 200 may be provided by any device capable of sending and receiving radio signals. Non-limiting examples comprise a mobile station (MS) or mobile device such as a mobile phone or what is known as a smart phone, a computer provided with a wireless interface card or other wireless interface facility (e.g., USB dongle), personal data assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The communication device 200 is provided with at least one data processing entity 201 and at least one memory 202. Typical communication devices 200 are further provided with other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also be a device having capability to operate in Internet of Things (loT) network which is a scenario in which objects are provided with the ability to transfer data over a network without requiring human-to-human or human-to-computer interaction. One technology in the above network may be denoted as narrowband Internet of Things (NB-Iot). The communication device 200 may also be a device having capability to operate utilizing enhanced machine-type communication (eMTC). The communication device 200 may also utilize cloud.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be coupled (e.g., communicatively; directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200 (e.g., the functioning of the transmitter and receiver, the display 208, or the at least one memory 202).

In general, the term ‘processor’ refers to a device that is capable of processing data. Depending on the processing power needed, the apparatus 200 may comprise several processors, such as parallel processors, a multicore processor, or a computing environment that simultaneously utilizes resources from several physical computer units (sometimes these are referred as cloud, fog or virtualized computing environments). When designing the implementation of the processor, a person skilled in the art will consider the requirements set for the size and power consumption of the apparatus, the necessary processing capacity, production costs, and production volumes, for example.

A non-exhaustive list of implementation techniques for the processor and the memory includes, but is not limited to: logic components, standard integrated circuits, application-specific integrated circuits (ASIC), system-on-a-chip (SoC), application-specific standard products (ASSP), field programmable gate arrays (FPGA), microprocessors, microcontrollers.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like), or 5G beyond. For example, the communication device 200 may be capable of operating in accordance with 4G wireless communication protocols, such as LTE Advanced, 5G, and/or the like as well as similar wireless communication protocols that may be subsequently developed.

The communication device 200 may comprise memory, such as the at least one memory 202. The term ‘memory’ refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory. At least part of the volatile and/or non-volatile memory may be embedded in the processor.

For example, communication device 200 may comprise one or more Subscriber Identity Modules (SIM), one or more Universal Subscriber Identity Modules (USIM), one or more removable User Identity Modules (R-UIM), one or more eUICC, one or more UICC, and/or the like, which may store information elements related to a mobile subscriber. The memories may comprise an identifier, such as an International Mobile Equipment Identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

In some embodiments, the communication device 200 (i.e., a user equipment (UE) or a user device in a network) comprises the processor (e.g., the at least one data processing entity 201) and the memory (e.g., the at least one memory 202). The memory includes computer program code causing the communication device 200 to perform processing according to the methods described further below.

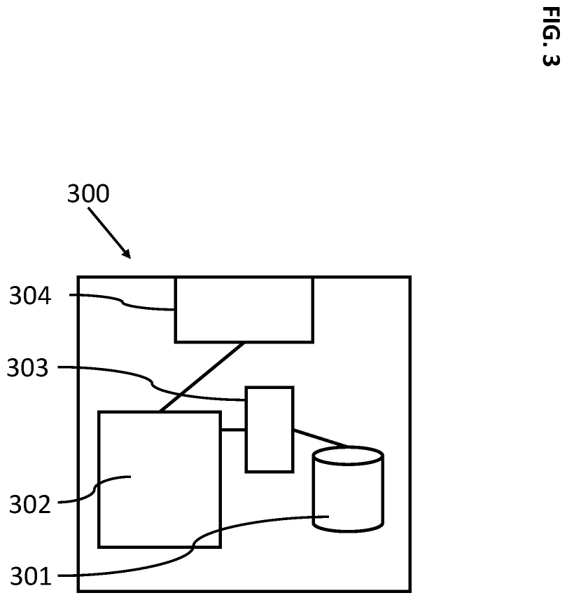

FIG. 3 shows an example embodiment of a control apparatus for a communication system, for example to be coupled to and/or for controlling a station of an access system, such as a RAN node, e.g., a base station, eNB or gNB, a relay node or a core network node. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301 and at least one data processing unit 302, 303. Memory (e.g., the at least one memory 301) stores program instructions and data to control the operations of the control apparatus 300. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. The control apparatuses 300 may further comprise an input/output interface 304, via which the control apparatus 300 can be coupled to, e.g., a receiver and a transmitter of a base station.

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes instructions, i.e., computer program code, causing the control apparatus 300 to perform processing according to the method described further below.

Multipath and sidelink connections represent one core advantage of the 5G system and are used to enhance the connectivity between different devices allowing devices and infrastructures to connect and communicate amongst themselves, extending coverage via device-to-device communication with multi-hop mesh relays, improving positioning accuracy for diverse situations, including challenging scenarios such as dense urban areas and tunnels and providing high throughput to devices in proximity to each other, enabling data-intensive use cases such as gaming and data backup.

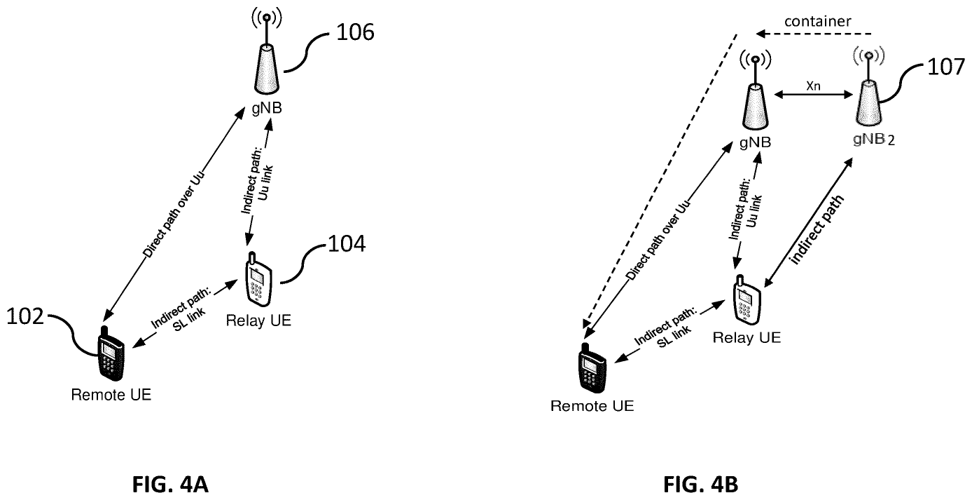

Referring to FIG. 4A, an example setup for multi path (MP) connection to a gNB 106 is shown for a first UE 102 (which is herein referred to as remote UE) over a second UE 104 (which is herein referred to as relay UE). The remote UE 102 has established a direct data path over the Uu interface to the gNB 106, and is also simultaneously connected over an indirect path to the gNB 106. The indirect path is established by a UE-to-Network (U2N) connection (e.g., an L2 U2N connection) over the relay UE 104 via sidelink (SL), whereby the relay UE 104 is connected to the gNB 106. So, the remote UE 102 is connected to the same gNB 106 over two different ways in this scenario.

In another embodiment for the multipath setup in FIG. 4B, the remote UE 102 is configured to add the indirect path with another gNB 107 (e.g., the target gNB of the indirect path) rather than the serving gNB 106 of the direct path. In this scenario, the target gNB 107 of the indirect path makes the relay UE 104 selection according to RAN3 agreement. In this case, the target gNB 107 knows the RRC state of the selected relay UE 104 based on the relay UE's measurement report.

In one embodiment, the target gNB 107 may indicate the selected relay UE's RRC state over the Xn interface to the serving gNB 106 of the remote UE's 102 direct path. In another embodiment, the selected relay UE's 104 RRC state indication may be included in the remote UE's 102 RRC container that the target gNB 107 sends to the remote UE 102 via the serving gNB 106 of the direct path.

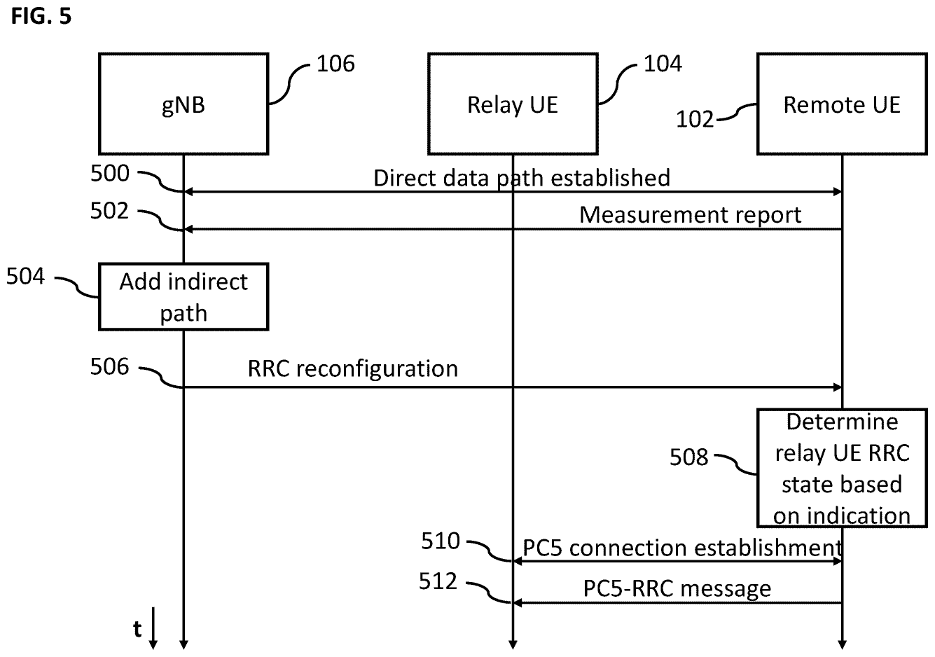

This invention proposes an indication from the network (NW), i.e., from the gNB, to the remote UE about the relay UE's RRC state if the indirect path is added to the remote UE, e.g., during RRC reconfiguration procedure. In case the relay UE's RRC state is not RRC_Connected, the invention further proposes a method for triggering the relay UE to transit to RRC_Connected state. For this proposed indication, there are several options which are explained in different embodiments of this invention with respect to FIGS. 5 to 8.

For example, FIG. 5 represents a simplified form of the MP configuration. This form of implementation example is visualized in the form of sequence diagram.

At 500, it is assumed the remote UE 102 has established the direct connection with the gNB 106. At 502, the gNB 106 receives a measurement report from the remote UE 102. The measurement report includes the discovered candidate relay UEs. The measurement report may further include the corresponding SL Reference Signaling Received Power (SL-RSRP) or Sidelink discovery-Reference Signal Received Power (SD-RSRP) of each relay UE in the reported candidate list.

Based on the received measurement report, the gNB 106 may make the decision, at 504, to add the indirect path to the remote UE 102 to have multipath connection. In such a multipath connection, the remote UE 102 may be connected to the same gNB 106 using both a direct path and an indirect path via another UE (e.g., via a relay UE selected from the candidate relay UEs).

The gNB 106 then initiates, at 506, the RRC reconfiguration procedure to configure the remote UE 102 to setup the indirect path via the relay UE 104, which has been selected from the list of discovered candidate relay UEs. According to a standardized procedure, the relay UE 104 in RRC_Connected state will report the UE-type as the relay UE 104 as well as the ID to the gNB 102 in SidelinkUEInformationNR message. So, the gNB 106 is aware of whether the selected relay UE 104 is in RRC Connected state or not.

Thus, the gNB 106 can indicate the RRC state of the selected relay UE 104 in the same RRC reconfiguration message that is transmitted, at 506, to the remote UE 102 to configure the remote UE 102 to add the indirect path via the selected relay UE 104.

In one embodiment, the RRC reconfiguration message is extended with a new Information Element (IE) including the relay UE 104 state (e.g., RRC_Connected, RRC_Idle or RRC_Inactive) or the message may include a True or False value for the RRC_Connected state.

In another embodiment, the RRC reconfiguration message indicates whether the RRC reconfiguration complete message from the remote UE 102 is to be transmitted to the gNB 106 via the direct path or indirect path. An indication that the indirect path is to be used implicitly indicates that the relay UE 104 is not in RRC_Connected state. In this case, the RRC reconfiguration complete message transmitted via indirect path will trigger the relay UE 104 to transit to RRC_Connected state.

Alternatively, or in addition, the RRC reconfiguration message includes the configuration of a Signaling Radio Bearer (SRB) of the remote UE 102 (i.e., whether a split SRB is configured or not). For example, the remote UE's SRB being configured as split bearer may indicate that the relay UE is not in RRC_Connected state. In this case, the RRC reconfiguration complete message may be transmitted from the remote UE 102 to the gNB 106 via the indirect path.

In another embodiment, the RRC reconfiguration message includes an RRC container of the relay UE 104, which indicates that the relay UE is not in RRC_Connected state. In this case, the remote UE 102 may transmit the RRC container to the relay UE 104, e.g., included in the RRC reconfiguration complete message or in a PC5-RRC message.

At 508, the remote UE 102 determines the RRC state of the relay UE 104 based on the indication received from the serving gNB 106. Depending on the transmitted indication of the RRC state of the relay UE 104, the remote UE 102 sends an RRC reconfiguration complete message back to the gNB 106 via a direct path or via an indirect path over the relay UE 104. Upon determining the relay UE 104 is not in RRC_Connected state, the remote UE 102 will send, at 512, a PC5-RRC message (or, alternatively, the RRC reconfiguration complete message) to the relay UE 104 to trigger the relay UE setup/resume its own RRC connection with the gNB 106, after the remote UE has initiated a device to device connection over the PC5 interface to the relay UE 104, at 510, and the PC5 connection has been established.

The PC5 RRC message may be an RRCReconfigurationSidelink message with the extension of adding a new information element (IE) for triggering the relay UE to setup/resume its own connection with the gNB 106 or a new gNB. In another embodiment, the PC5 _RRC message may be the UEAssistanceInformationSidelink or the RemoteUEInformationSidelink with the extension of adding a new IE for triggering the relay UE to setup/resume its own connection with gNB 106 or a new gNB. In another embodiment, the PC5 _RRC message may be a new SL RRC message. Moreover, the PC5-RRC message may also be replaced by the RRC reconfiguration complete message that the remote UE 102 sends to the relay UE 104 via SL-Radio Link Control (SL-RLC) channel that is configured for transmitting a Signaling Radio Bearer 1 (SRB1) message of the remote UE 102 over the PC5 interface.

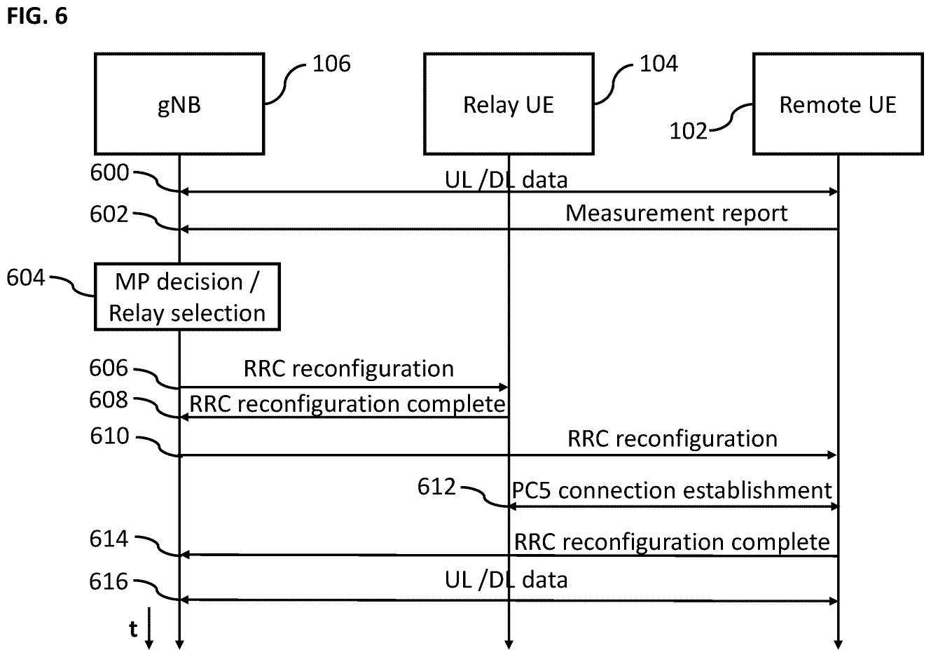

In the embodiment shown in FIG. 6, the relay UE 104 is in RRC_Connected state. In this scenario, the remote UE 102 will send the RRC reconfiguration complete message to the gNB 106 through the direct path, because the relay UE 104 does not need to be triggered to initiate the RRC establishment/resume procedure. Here, the RRC state of the relay UE 104 can be indicated explicitly by RRC state indication or implicitly by the path indication indicating the direct path as a path to send the RRC reconfiguration complete message.

The gNB 106 has an established data connection, at 600, to the remote UE 102 via direct path, i.e. the remote UE 102 is able to upload or download data directly to or from the gNB. As above, the remote UE 102 transmits the measurement report, at 602, to the gNB 106 including information about possible candidate relay UEs. The measurement report may further include the corresponding SL-/SD-RSRP for each candidate relay UE. Note that, the remote UE 102 does not know if one of the possible candidate relay UEs has an existing connection to the serving gNB 106 or an another gNB yet.

Therefore, at 604, the gNB 106 decides, depending on the measurement report, which of the candidate relay UEs may serve as a relay UE 104 for a multipath connection. As the relay UE 104 is already in RRC_Connected state, the gNB 106 can directly send the RRC reconfiguration message, at 606, to the relay UE 104, and inform the relay UE 104 about the multipath connection that will be established. The relay UE 104 sends the RRC reconfiguration complete message back to the gNB 106 at 608.

At 610, the gNB 106 transmits the RRC reconfiguration message to the remote UE 102, thereby configuring the multipath connection to be added via the relay UE 104. Thereupon, the remote UE 102, establishes a PC5 connection, at 612, to the relay UE 104 to establish an indirect path to the gNB 106 for the multipath connection.

Now, at 614, the remote UE 102 may transmit the RRC reconfiguration complete message back to gNB 106 via the direct path, as there is no need to trigger the relay UE 104 to transit into RRC_Connected state. Finally, at 616, the data connection is still present to the gNB 106, but it also has an indirect path over the relay UE 104.

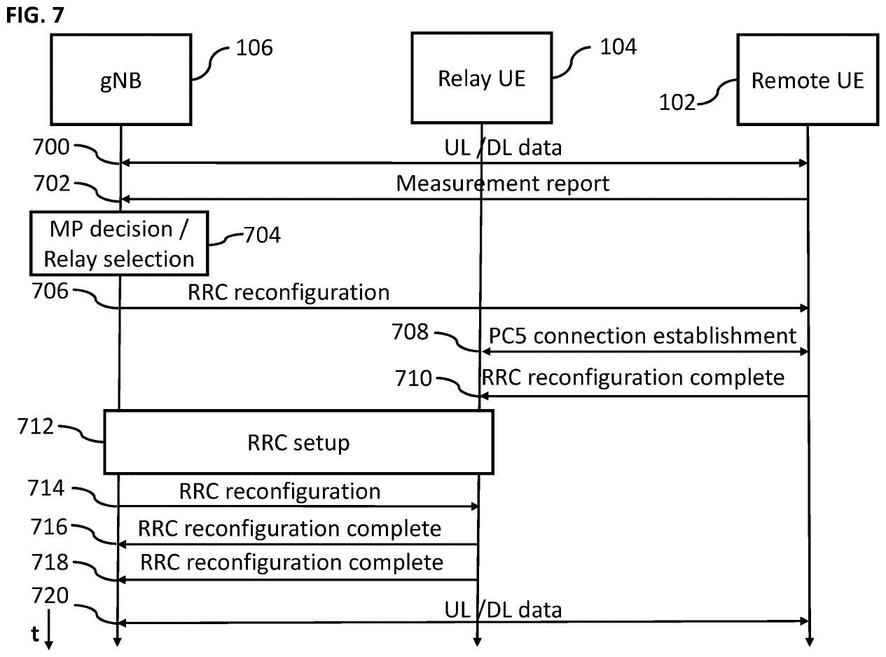

In a further embodiment, shown in FIG. 7, the relay UE 104 is not in RRC Connected state and the remote UE 102 triggers the relay UE 104 to transit into RRC Connected state. In such cases, the indication of the RRC state of the relay UE 104 may be implicitly or explicitly indicated by the gNB 106. The setup is the same as above.

At 700, the remote UE 102 has established the direct connection with the gNB 106. That is, data can be downloaded or uploaded between the remote UE 102 and the gNB 106 directly. At 702, the gNB 106 receives a measurement report from the remote UE 102, the measurement report including a list of all possible relay UE candidates.

Based on that list, the gNB 106 decides, at 704, to establish a multipath connection for the remote UE by selecting a relay UE 104. Due to the relay UE 104 being not in RRC_Connected state, the gNB 106 can not directly inform the selected relay UE from the candidate list about the intention to use it as a relay UE 104. Therefore, the relay UE's 104 configuration for the relaying operation can be provided only after the relay UE 104 transits to RRC_Connected state or to the relay UE 104 from the gNB 106 via the remote UE 102.

On the one hand, the gNB 106 may explicitly indicate the relay UE's 104 ID and the current RRC state to the remote UE 102 in the RRC reconfiguration message, e.g. as an additional IE in the message. In this case, the remote UE 102 may send, at 708, a PC5-RRC message to trigger the relay UE 104 to transit from RRC_Idle or RRC Inactive state to RRC Connected state.

On the other hand, the gNB 106 may implicitly indicate the RRC state of the relay UE 104 by indicating the SRB configuration. If split SRB is configured, it indicates the relay UE 104 is not in RRC_Connected state. In this case, the relay UE 104 needs to be triggered to transit to RRC_Connected state by the remote UE when the remote UE sends the RRC reconfiguration complete message via the relay UE 104, which triggers the relay UE 104 to initiate an RRC establishment or resume procedure. For this, a RRC reconfiguration complete message is transmitted, at 710, from the remote UE 102 to the relay UE 104 after having established a PC5-RRC connection therebetween, at 708. If non-split SRB is configured, it indicates the relay UE is in RRC_Connected state.

In another example, the NW may indicate which path of the split SRB is used for transmission of the RRC reconfiguration complete message. For example, for a split SRB configured for the remote UE 102, the NW may set the path to transmit the RRC reconfiguration complete message to the indirect path if the relay UE 104 is not in RRC Connected state. Then, the remote UE 102 sends the RRC reconfiguration complete message over the indirect path, which triggers the relay UE 104 to transit to RRC_Connected state. If the relay UE 104 is in RRC_Connected state, the NW may set the path to the direct path of the split SRB because the relay UE does not need to initiate the RRC establishment procedure at all.

In another example, the gNB 106 may implicitly indicate the RRC state of the relay UE 104 by including an RRC container of the relay UE 104 in the remote UE's 102 RRC reconfiguration message, or not. For instance, if the relay UE's 104 RRC container is included, it indicates that the relay UE 104 is not in RRC_Connected state. Otherwise, it indicates the relay UE is in RRC_Connected state.

In this embodiment, where the relay UE 104 is not in RRC_Connected state, the explicit or implicit indication is included in the RRC reconfiguration message of the remote UE 102, which is transmitted at 706.

Upon receiving RRC reconfiguration message from the gNB 106 for configuring to add the indirect path via the relay UE 104, the remote UE 102 establishes, at 708, a PC5 connection to the relay UE 104. After having established this PC5 connection, based on the indication that the relay UE 104 is not in RRC_Connected state, the remote UE 102 transmits the RRC reconfiguration complete message to the relay UE 104, thereby triggering the relay UE 104 to transit its RRC state from RRC Idle or RRC Inactive state to RRC Connected state. In case that the RRC state of the relay UE 104 has been indicated to the remote UE 102 by including the RRC container of the relay UE 104 in the RRC reconfiguration message, this RRC container is also transmitted to the relay UE 104 by the RRC reconfiguration complete message transmitted at 710 or a PC5 RRC message.

Now, at 712, the relay UE 104 initiates the RRC setup to connect to the gNB 106. At 714, the gNB 106 transmits another RRC reconfiguration message to the relay UE 104 directly via the Uu interface. The relay UE 104 responds thereto with a corresponding RRC reconfiguration complete message at 716. With the established RRC connection and the relay UE 104 being in RRC_Connected state, the relay UE 104 can now forward the RRC reconfiguration complete message from the remote UE 102 back to the gNB 106 at 718.

Finally, at 720, the gNB 106 has a multipath connection to the remote UE 102 via direct path and over the relay UE 104 to the remote UE 102 via indirect path.

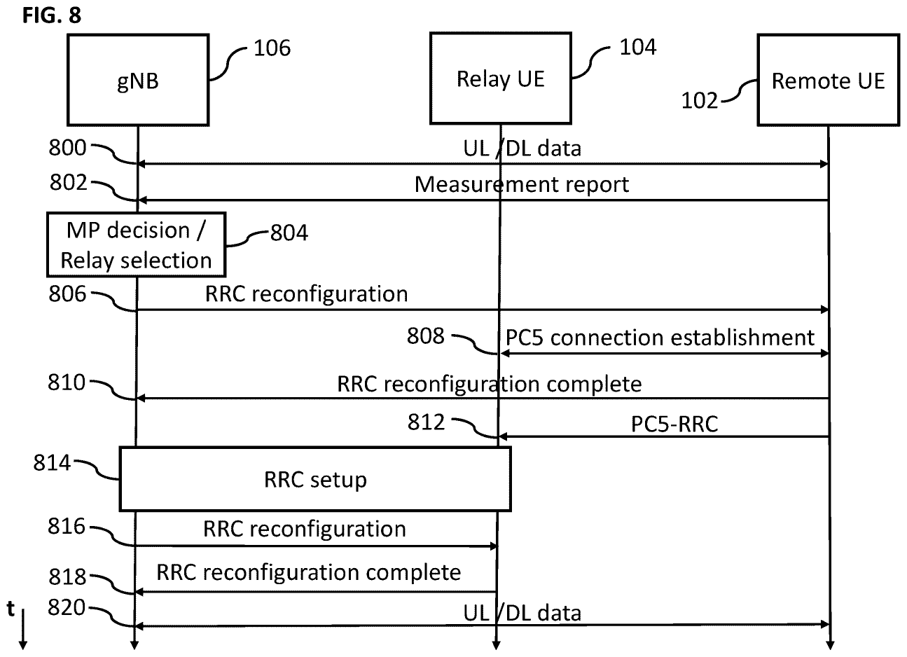

In another embodiment, with respect to FIG. 8, the RRC reconfiguration complete message is transmitted from the remote UE 102 to the gNB 106 over the direct path even though the relay UE 104 is not in RRC Connected state.

and transmit a PC5-RRC message to the relay UE 104 to trigger the relay UE 104 to establish/resume its own RRC connection concurrently to allow faster completion of the multipath setup.

As in the embodiments above, at 800, the remote UE 102 has established the direct connection with the gNB 106. At 802, the gNB 106 receives a measurement report from the remote UE 102, the measurement report including a list of possible relay UE candidates.

From this list of relay UE candidates, the gNB 106 selects, at 804, a relay UE 104 and transmits, at 806, the RRC reconfiguration message including an indication of the relay UE's 104 RRC state to the remote UE 102.

In one example, the RRC reconfiguration message may further indicate to the remote UE 102 which path to use for transmitting the RRC reconfiguration complete message back to the gNB 106.

In contrast to the previous embodiments, the RRC reconfiguration message may indicate that the direct path is to be used for transmitting the RRC reconfiguration complete message although the relay UE 104 is not in RRC_Connected state. In this case, the remote UE 102 transmits, at 810, the RRC reconfiguration complete message back to the gNB 106 via the direct path, and establishes a PC5 connection to the indicated relay UE 104 at 808. The relay UE 104 can then be triggered to transit to RRC_Connected state by a PC5-RRC message transmitted, at 812, from the remote UE 102 to the relay UE 104.

In another example, when the path to use for transmitting the RRC reconfiguration complete message has not been indicated in the RRC reconfiguration message, the remote UE 102 may still decide to transmit, at 810, the RRC reconfiguration complete message back to the gNB 106 via the direct path although the relay UE 104 is not in RRC_Connected state. The remote UE's 102 decision on whether to transmit the RRC reconfiguration complete message directly back to the gNB 106 may be dependent on some parameters, e.g. the amount of buffered data and urgency of increased throughput or urgency to increase reliability.

In this case, the remote UE 102 also establishes, at 808. a PC5 connection to the indicated relay UE 104, and transmits, at 812, a PC5-RRC message to the relay UE 104, thereby triggering the relay UE 104 to transit to RRC Connected state.

As a result, the RRC setup procedure 814 is initiated between the gNB 106 and the relay UE 104.

At 816, the gNB 106 sends another RRC reconfiguration message to the relay UE 104, and the relay UE 104 responds thereto, at 818, with a corresponding RRC reconfiguration complete message to the gNB 106. Finally, the data connection between the gNB 106 and the remote UE 102 is extended with the indirect path over the relay UE 104.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

1. A method, performed at a user equipment (UE), comprising:
transmitting, to a base station via a direct path, a measurement report comprising a list of one or more candidate relay UEs;
receiving, from the base station, a configuration message comprising an identifier (ID) of a relay UE selected from the one or more candidate relay UEs, wherein the configuration message further indicates an RRC state of the selected relay UE;
determining, based on the received configuration message, whether the selected relay UE is in RRC Connected state or not; and
initiating, upon determining that the selected relay UE is not in RRC Connected state, a procedure to the relay UE to trigger the relay UE transition to RRC Connected state.

2. The method of claim 1, wherein the RRC state of the selected relay UE is indicated explicitly in the configuration message.

3. The method of claim 2, wherein the configuration message further indicates the path to be used by the remote UE for transmitting the configuration response message.

4. The method of claim 1, wherein the RRC state of the selected relay UE is indicated by indicating whether a split Signaling Radio Bearer (SRB) is configured or not, or by indicating the path to be used by the remote UE for transmitting a configuration response message.

5. The method of claim 4, wherein a split SRB is not configured when the selected relay UE is in RRC Connected state, and a split SRB is configured when the selected relay UE is not in RRC Connected state.

6. The method of claim 4, wherein the direct path is indicated when the selected relay UE is in RRC Connected state, and the indirect path is indicated when the selected relay UE is not in RRC Connected state.

7. The method of claim 1, wherein the RRC state of the selected relay UE is indicated by the configuration message further including an RRC container of the selected relay UE or not.

8. The method of claim 7, wherein the RRC container is not included in the configuration message when the selected relay UE is in RRC Connected state.

9. The method of any of preceding claims, further comprising:
upon determining that the selected relay UE is in RRC Connected state, transmitting an configuration response message via the direct path to the base station.

10. The method of any of preceding claims, wherein the procedure to the relay UE comprises one of the following:
transmitting, via the indirect path, an configuration response message to the selected relay UE, or
transmitting, via the indirect path, a PC5-RRC message to the selected relay UE.

11. A method, performed at a base station, comprising:
receiving, from a User Equipment (UE) via a direct path, a measurement report comprising a list of one or more candidate relay UEs;
determining to add an indirect path to the UE via a relay UE selected from the one or more candidate relay UEs to have a multipath connection;
transmitting, to the UE, a configuration message comprising an identifier (ID) of the selected relay UE, wherein the configuration message further indicates an RRC state of the selected relay UE.

12. The method of claim 11, wherein the RRC state of the selected relay UE is indicated explicitly in the configuration message.

13. The method of claim 11, wherein the RRC state of the selected relay UE is indicated by indicating whether a split Signaling Radio Bearer (SRB) is configured or not, or by indicating the path to be used by the remote UE for transmitting a configuration response message.

14. The method of claim 13, wherein a split SRB is not configured when the selected relay UE is in RRC Connected state, and a split SRB is configured when the selected relay UE is not in RRC Connected state.

15. The method of claim 13, wherein the direct path is indicated when the selected relay UE is in RRC Connected state, and the indirect path is indicated when the selected relay UE is not in RRC Connected state.

16. The method of claim 11, wherein the RRC state of the selected relay UE is indicated by the configuration message further including an RRC container of the selected relay UE or not.

17. The method of claim 11, further comprising receiving, from another base station, an indication of the RRC state of the selected relay UE.

18. An apparatus comprising:
at least one processor; and
at least one memory including executable instructions that, when executed by the at least one processor, cause the apparatus to:
receive, from a User Equipment (UE) via a direct path, a measurement report comprising a list of one or more candidate relay UEs;
determine to add an indirect path to the UE via a relay UE selected from the one or more candidate relay UEs to have a multipath connection;
transmit, to the remote UE, a configuration message comprising an identifier (ID) of the selected relay UE, wherein the configuration message further indicates an RRC state of the selected relay UE.

19. The apparatus of claim 18, wherein the RRC state of the selected relay UE is indicated explicitly in the configuration message.

20. The apparatus of claim 19, wherein the configuration message further indicates the path to be used by the remote UE for transmitting the configuration response message.

21. The apparatus of claim 18, wherein the RRC state of the selected relay UE is indicated by indicating whether a split Signaling Radio Bearer (SRB) is configured or not, or by indicating the path to be used by the remote UE for transmitting a configuration response message.

22. The apparatus of claim 21, wherein a split SRB is not configured when the selected relay UE is in RRC Connected state, and a split SRB is configured when the selected relay UE is not in RRC Connected state.

23. The apparatus of claim 21, wherein the direct path is indicated when the selected relay UE is in RRC Connected state, and the indirect path is indicated when the selected relay UE is not in RRC Connected state.

24. The apparatus of claim 18, wherein the RRC state of the selected relay UE is indicated by the configuration message further including an RRC container of the selected relay UE or not.

25. The apparatus of claim 24, wherein the RRC container is not included in the configuration message when the selected relay UE is in RRC Connected state.

26. The apparatus of any of preceding claim 18 to 25, wherein the instructions, when executed by the processor, further cause the apparatus to:
upon determining that the selected relay UE is in RRC Connected state, transmitting an configuration response message via the direct path to the base station.

27. The apparatus of any of preceding claim 18 to 26, wherein the instructions, when executed by the processor, further cause the apparatus to:
transmit, via the indirect path, a configuration response message to the selected relay UE, or transmitting, via the indirect path, a PC5-RRC message to the selected relay UE.

28. An apparatus comprising:
at least one processor; and
at least one memory including executable instructions that, when executed by the at least one processor, cause the apparatus to:
transmit, to a base station via a direct path, a measurement report comprising a list of one or more candidate relay UEs;
receive, from the base station, a configuration message comprising an identifier (ID) of a relay UE selected from the one or more candidate relay UEs, wherein the configuration message further indicates an RRC state of the selected relay UE;
determine, based on the received configuration message, whether the selected relay UE is in RRC Connected state or not; and
initiate, upon determining that the selected relay UE is not in RRC Connected state, a procedure to the relay UE to trigger the relay UE transition to RRC Connected state.

29. The apparatus of claim 28, wherein the RRC state of the selected relay UE is indicated explicitly in the configuration message.

30. The apparatus of claim 28, wherein the RRC state of the selected relay UE is indicated by indicating whether a split Signaling Radio Bearer (SRB) is configured or not, or by indicating the path to be used by the remote UE for transmitting a configuration response message.

31. The apparatus of claim 30, wherein a split SRB is not configured when the selected relay UE is in RRC Connected state, and a split SRB is configured when the selected relay UE is not in RRC Connected state.

32. The apparatus of claim 30, wherein the direct path is indicated when the selected relay UE is in RRC Connected state, and the indirect path is indicated when the selected relay UE is not in RRC Connected state.

33. The apparatus of claim 28, wherein the RRC state of the selected relay UE is indicated by the configuration message further including an RRC container of the selected relay UE or not.

34. The apparatus of claim 28, further comprising receiving, from another base station, an indication of the RRC state of the selected relay UE.
